(19) United States
(12) Patent Application Publication
(10) Pub. No.: US 2004/0131505 A1
(43) Pub. Date: Jul. 8, 2004

(54) Dispenser, dispenser array, manufacturing method for dispenser, inspection device, inspection method and biochip

(75) Inventor: Hiroshi Koeda, Nagano (JP)

Correspondence Address: STERNE, KESSLER, GOLDSTEIN & FOX PLLC, 1100 NEW YORK AVENUE, N.W., WASHINGTON, DC, 20005, US

(73) Assignee: Seiko Epson Corporation

(21) Appl. No.: 10/626,829

(22) Filed: Jul. 25, 2003

(30) Foreign Application Priority Data
Jul. 26, 2002 (JP) 2002-218980

(51) Int. Cl. B01L 3/00

(52) U.S. Cl. 422/100; 422/58

(57) ABSTRACT

The present invention provides a dispenser which can inspect and manufacture a biochip by attaching various kinds of liquid samples accurately and at a high speed. The dispenser comprises liquid discharge means (12) for discharging liquid and identification information holding means (200) for holding, in a readable manner, the identification information for identifying liquid. According to this configuration, the liquid to be discharged from the dispenser can be identified by recognizing identification information. The micro-dispensers, in particular, which are used for the inspection and manufacture of biochips frequently use various kinds of polymer material all at once. If the present invention is applied here, liquid of the respective micro-dispensers can be identified before discharge, so the correct liquid can be discharged in a reliable and accurate manner.

### BACKGROUND OF THE INVENTION

1. Field of the Invention

The present invention relates to an inspection or manufacturing technology of biochips, and more particularly to a dispenser which is suitable for the case when a liquid sample for various kinds of inspections or manufacturing is used.

2. Description of the Related Art

Recently biochips are used in attempts to perform information processing close to organisms using various kinds of biopolymers, such as DNA, RNA and protein, or to simplify the testing of nucleic acid and protein for clinical diagnosis and pharmacotherapy. For such biochips, a biochip where a probe DNA is dropped (spotted) on a bonding agent coated on a substrate has been used as a biosensor for inspection, for example. To inspect the nature of protein, a sample DNA, on which fluorescent material which bonds with the probe DNA and to be a marker, is bonded with the spotted probe DNA, and the fluorescent material is detected by laser light.

For example, Japanese Patent Application Laid-Open No. 2000-157272 discloses a biochip where the DNA probe and the bonding agent are locally attached on the plate, and the probe is planted in a position at which the bonding agent is attached. As this document discloses, the sample has been attached, using a pin or capillary tube, to such a sample as a DNA probe on the plate.

### SUMMARY OF THE INVENTION

With biochips, however, more than 100 and sometimes several hundreds of spots must be formed, using various kinds of biopolymers such as protein. In the case of a conventional method using pins and capillary tubes, these many spots cannot be formed at high-speed without error.

Also in a biochip, many different samples are disposed on a same substrate, so the samples must be attached with specifying the position for each type of sample. So various kinds of samples, which are difficult to distinguish visually, must be correctly identified and attached.

With the foregoing in view, it is an object of the present invention to provide a dispenser which can attach various kinds of liquid samples at high-speed and accurately.

The dispenser of the present invention comprises liquid discharge means for discharging liquid, and identification information holding means for holding, in a readable manner, identification information for identifying the liquid.

According to this configuration, the liquid which is discharged from the dispenser can be identified by recognizing the identification information. Particularly for the dispenser array to be used for inspecting and manufacturing the biochip, various kinds of polymer materials are used all at once in many cases. If the present invention is applied here, the liquid of each dispenser can be identified before discharge, so the correct liquid can be discharged with certainty and accuracy.

In the present invention, “liquid” is not particularly restricted, and various “liquids” can be defined according to the object of the dispenser. For example, if the dispenser is used for the inspection or manufacture of biochips, a liquid containing a biopolymer, such as various DNA, RNA and protein, and an analogous substance thereof is possible. If the dispenser is used for the manufacturing device of industrial products, a material solution for industrial use containing metal and film formation material is possible.

The structure of the “liquid discharge means” is not particularly restricted, but can be a structure comprising a tank for storing the liquid and a head chip for discharging the liquid stored in the tank, for example. The “tank” may be a disposable sealed tank or a replaceable ink cartridge. Possible structures to discharge liquid are an electrostatic drive type head, a piezo-drive type head, and a thermal drive type ink jet head. The electrostatic drive type head has a structure where an electrode is disposed adjacent to the diaphragm, which is a wall face of the pressure chamber substrate on which the pressure chamber is disposed, and discharges liquid in the pressure chamber by changing the volume of the pressure chamber by transforming the diaphragm which is a wall face of the pressure chamber, using electrostatic force, which is generated when a predetermined voltage is applied between the pressure chamber substrate and the electrode. The piezo-drive type head has a structure where a piezo-electric element is disposed on the diaphragm which is a wall face of the pressure chamber, and discharges liquid inside the pressure chamber by changing the volume of the pressure chamber by transforming the diaphragm by applying a predetermined voltage to the piezo-electric element. The thermal drive type head has a structure where a heat applying means is disposed at a predetermined location of the liquid channel, and discharges liquid using pressure occurred when the heat applying means is heated by applying predetermined voltage to the heat applying means, and generating bubbles in the liquid.

“Identification information” is simply information sufficient for specifying the liquid, and includes, for example, predetermined codes and characters, and information which allows distinction by physical, chemical and mechanical features. For example, the identification information includes the case when unique characteristics of reflectance, transmittance and refractive index in light, and wavelength, amplitude and phase of electromagnetic waves (lights), are assigned to each dispenser.

“Identification information holding means” is sufficient if it corresponds with the liquid discharge means, and the position where the holding means is disposed is not particularly restricted. In other words, the identification information holding means, for example, can be integratedly disposed around the liquid discharge means. For example, the identification information holding means can be formed integratedly with the head chip, or disposed at the tank, or disposed on the body of the dispenser. The identification information holding means can also be disposed at a position distant from the liquid discharge means. For example, the information holding means may also be formed like an index at a specified location, so that the liquid of the corresponding dispenser can be identified. It is also possible to dispose the information holding means at the side of the target to which the liquid is discharged, such as the plate of the biochip, so that liquid is discharged to the position when the identification information held by the information holding means, which is disposed on both the dispenser and the plate, match.

The structure of the “identification information holding means” is not restricted, and it is sufficient if the identification information can be held at least for a predetermined period. For example, the identification information holding means may have a configuration which is capable of transmitting electromagnetic waves for indicating the identification information to be held. With this configuration, the identification information can be recognized by receiving electromagnetic waves from the transmission section, so detection is possible in a non-contact status.

In this case, the identification information holding means can be comprised of a storage section for storing the identification information, a transmission section for transmitting the identification information, and a control section for reading the identification information stored in the storage section and transmitting the identification information via the transmission section, for example.

The identification information holding means in this case is preferably structured such that the identification information can be updated. This is because the identification information can be updated according to the liquid which is later filled, or identification information can be updated each time the liquid is changed, since an update of the identification information is possible. The storage section for making the identification information updatable can be various RAMs, EPROMs and EEPROMs, for example.

Also the identification information holding means may have a structure which influences the transmission or reflection of light, disposed corresponding to the identification information to be held, for example. With this configuration, the identification information can be recognized with certainty in a range where light from the holding means reaches, and also the identification number can be visually recognized. For such a structure, a barcode or holes, for example, is possible. Here “hole” may be a through hole or a non-through hole, such as a concave section or groove.

Also the identification information holding means may comprise a structure which has influence on electric continuity, disposed corresponding to the identification information to be held, for example, with this configuration, the identification information can be recognized by a relatively simple detection method of detecting the continuity of electricity. An example of such a structure includes an electrode pattern for conducting or not conducting the electrode pairs for identification information recognition, which are contacted from the outside.

Also the identification information holding means may comprise a predetermined stereoscopic structure corresponding to the identification information to be held, for example. If the stereoscopic structure has a unique shape, the identification information can be recognized by mechanical means, and the identification number can also be visually recognized. For such a stereoscopic structure, a key seat structure for engaging with a key for identification information recognition, which is inserted from the outside, is possible.

The present invention is also a dispenser array comprising a plurality of dispensers according to the present invention, where the identification information for specifying the liquid stored in each dispenser is provided corresponding to each dispenser. With this configuration, liquid to be discharged from each dispenser can be recognized with certainty and accuracy, free of error, by the identification information, even if various types of liquid are discharged from each dispenser.

The manufacturing method for a dispenser according to the present information comprises a step of creating identification information holding means for holding identification information for identifying liquid at a predetermined area, a step of creating a liquid channel, including a pressure chamber for applying pressure to the liquid, on a pressure chamber substrate, and a step of creating applying means for applying pressure to the pressure chamber.

Here the position to create the identification information holding means is not restricted, as described above. In the step of creating the identification information holding means, a configuration which allows transmitting electromagnetic waves for indicating the identification information to be held may be created in the area, or a structure which influences the transmission or reflection of light may be created in the area corresponding to the identification information to be held, or a structure which influences the continuity of electricity may be created in the area corresponding to the identification information to be held, or a predetermined stereoscopic structure may be created in the area corresponding to the identification information to be held.

The step of creating the liquid channel may further comprise a step of creating micro-channels, including a nozzle for discharging the liquid and a step of creating the pressure chamber and a reservoir. This manufacturing method is suitable for manufacturing the head structure which does not require a nozzle plate.

The step of creating the applying means may further comprise a step of creating a concave section at a position corresponding to the pressure chamber on an electrode housing substrate to be connected with the pressure chamber substrate, a step of creating an electrode in the concave section, and a step of gluing the electrode housing substrate and the pressure chamber substrate. This manufacturing method is an example of a manufacturing method for an electrostatic drive type head.

The inspection device according to the present invention comprises a recognition device for recognizing identification information disposed corresponding to a dispenser for discharging liquid, a transporting device for transporting the dispenser corresponding to the identification information to a predetermined discharge position based on the identification information recognized by the recognition device, and a discharge control device for allowing the dispenser transported to the discharge position to discharge the liquid.

According to this configuration, liquid to be discharged from the dispenser can be specified by the recognition device recognizing the identification information, so the specified liquid can be transported to an appropriate position to be discharged and then the liquid to be discharged. Therefore the liquid in each dispenser can be discharged with certainty and accuracy to the corresponding position. Particularly if the present invention is applied to a dispenser array which is constructed to discharge various kinds of liquids, the target liquid can be discharged at an appropriate position one after another in a short time.

“The inspection device” in the present invention may be used as a manufacturing device by including material for biochip manufacturing in the liquid to be discharged.

It is preferable that the inspection device according to the present invention further comprise a sensor for detecting the identification information and outputting electric signals corresponding to the identification information, and a sensor drive device for driving the sensor to a position where the identification information corresponding to one dispenser can be detected. With this configuration, the sensor is moved to a position where the sensor can detect an arbitrary dispenser, so in a dispenser array which is constructed such that various kinds of liquids can be discharged, the sensor can be moved to a correct detection position without human hands.

Here the configuration of “the recognition device” is not restricted, and can be changed in various ways according to the aspect of the identification information. For example, the recognition device can be structured such that electromagnetic waves for indicating the identification information of the dispenser are received, and the identification information indicated by the electromagnetic waves can be regenerated. In this case, as a sensor, the inspection device comprises an antenna for receiving the electromagnet waves which are output from the identification information holding means where the identification information is held.

Also the recognition device can be structured such that the received light is detected and the identification information indicated by this light can be regenerated. In this case, as a sensor, the inspection device comprises a light receiving section for receiving reflected light or transmitted light of the light which is irradiated toward the identification information holding means where the identification information is held.

Also the recognition device can be constructed such that the continuity or discontinuity of electricity is detected and the identification information is recognized corresponding to the continuity or discontinuity of electricity. In this case, as a sensor, the inspection device comprises an electrode pair (probe) for detecting the continuity and discontinuity of electricity in a predetermined area of the identification information holding means where the identification information is held.

Also the recognition device can be structured such that a predetermined stereoscopic structure is detected and the recognition information indicated by the stereoscopic structure can be recognized. In this case, the sensor can be constructed such that the sensor can detect whether a key corresponding to a predetermined identification information engages with the key seat structure created corresponding to the identification information. And the recognition device judges that the dispenser corresponding to this key receiving seat has the identification information corresponding to this key if the sensor recognizes that the key has been engaged.

The inspection method according to the present invention comprises a step of recognizing identification information which is provided corresponding to a dispenser for discharging liquid, a step of transporting the dispenser corresponding to the identification information to a predetermined discharge position based on the recognized identification information, and a step of discharging the liquid from the dispenser transported to the discharge position.

According to these steps, the dispenser is transported according to the identification information corresponding to the dispenser, and the liquid is discharged at that position, so the predetermined liquid can be discharged at an appropriate position with certainty and accuracy.

“The inspection method” in the present invention may be used as a manufacturing method by including material for biochip manufacturing in the liquid to be discharged.

For this recognition method, method of transporting the dispenser to a discharging position, and discharge method of the liquid, various known technologies can be modified and used. For example, the above mentioned recognition method in the recognition device and the discharge method used for the liquid discharge means can be applied. A method of transportation is sufficient if the relative position between the dispenser and the discharge target location is changed, and this includes a case of transporting only the dispenser, a case of transporting only the discharge target object, and a case of transporting both the dispenser and the discharge target object.

The biochip according to the present invention is a biochip manufactured by the inspection method according to the present invention, wherein the liquid identified by the identification information contains polymer material, comprising a plate on which polymer material is attached at a position corresponding to the identified identification information. Since the inspection method according to the present invention makes it possible to attach polymer material at a predetermined location at high-speed with certainty and accuracy, a biochip of which the manufacturing unit price is low can be provided.

“The biochip” in the present invention may be a biosensor for inspection or a biochip to be the manufacturing target, such as an integrated circuit, and the configuration thereof is not particularly restricted, and includes the discharge target object for manufacturing or inspecting polymer material attached at a predetermined position. Examples are, biochips for inspection, which specifies the DNA chain by changing the electric characteristics due to the hybridization of the DNA chain, or biochips for detection, which detects the antigen-antibody reaction using antigen as a receptor, or detects the enzyme-substrate reaction using an enzyme as a receptor. In other words, depending on the type of the receptor, such biosensors as an enzyme sensor, immunity sensor, microorganism sensor, organelle sensor, tissue sensor and receptor sensor correspond to the biochips in the present invention.

For the manufacturing target, a bio-molecular device which is structured to have a different operation principle from the silicon device by programming the bio-molecules using self organization of the bio-molecules, and an integration device where a conventional electronic device and bio-molecules are integrated at the nano scale level, are included in the biochips mentioned here.

In other words, according to the present invention, arbitrary bio-molecules can be identified with certainty and can be attached at a predetermined position, therefore the present invention can provide biochips and bio-devices for various applications.

### BRIEF DESCRIPTION OF THE DRAWINGS

FIG. 1 is a perspective view depicting the dispenser array and the dispenser according to the first embodiment;

FIG. 2 is an exploded perspective view depicting the dispenser according to the first embodiment;

FIG. 3 is an exploded perspective view depicting the head chip according to the first embodiment;

FIG. 4 is a cross-sectional view depicting the head chip according to the first embodiment, and a cross-section view of the A-A cutting plane in FIG. 3;

FIG. 5 is a plan view depicting the identification information holding means according to the first embodiment;

FIG. 6 is a block diagram depicting the identification information holding means according to the first embodiment;

FIG. 7 are diagrams depicting the identification information holding means creation step according to the first embodiment, wherein FIG. 7A is a plan view, FIG. 7B is a cross-sectional view of the B-B cutting plane, and FIG. 7C is a cross-sectional view of the C-C cutting plane;

FIG. 8 is a cross-sectional view depicting the manufacturing steps in the semiconductor manufacturing steps of an EEPROM in the identification information holding means creation step according to the first embodiment;

FIG. 9 are diagrams depicting the oxide film creation step according to the first embodiment, wherein FIG. 9A is a plan view, FIG. 9B is a cross-sectional view of the B-B cutting plane, and FIG. 9C is a cross-sectional view of the C-C cutting plane;

FIG. 10 are diagrams depicting the channel creation step according to the first embodiment, wherein FIG. 10A is a plan view, FIG. 10B is a cross-sectional view of the B-B cutting plane, and FIG. 10C is a cross-sectional view of the C-C cutting plane;

FIG. 11 are diagrams depicting the oxide film creation and electrode housing substrate creation step according to the first embodiment, wherein FIG. 11A is a plan view, FIG. 11B is a cross-sectional view of the B-B cutting plane, and FIG. 1C is a cross-sectional view of the C-C cutting plane;

FIG. 12 is a block diagram depicting the inspection drive 30a according to the first embodiment;

FIG. 13 is a diagram depicting the inspection method according to the first embodiment;

FIG. 14 is a diagram depicting the transporting and the discharge steps in the inspection method according to the first embodiment;

FIG. 15 is a flow chart depicting the inspection method according to the first embodiment;

FIG. 16 is a plan view depicting the identification information holding means according to the second embodiment;

FIG. 17 are diagrams depicting the identification information holding means according to the third embodiment, wherein FIG. 17A is a plan view, FIG. 17B is a cross-sectional view of the B-B cutting plane, and FIG. 17C is a cross-sectional view of the C-C cutting plane;

FIG. 18 is a block diagram depicting the inspection device 30c according to the third embodiment;

FIG. 19 is a diagram depicting the inspection method according to the third embodiment;

FIG. 20 is a plan view depicting the identification information holding means according to the fourth embodiment;

FIG. 21 is a block diagram depicting the inspection device 30d according to the fourth embodiment;

FIG. 22 is a diagram depicting the inspection method according to the fourth embodiment;

FIG. 23 is a plan view depicting the identification information holding means according to the fifth embodiment; and

FIG. 24 are diagrams depicting a modification of the embodiment, wherein FIG. 24A is a perspective view, and FIG. 24B is a diagram depicting the inspection method.

### DESCRIPTION OF THE PREFERRED EMBODIMENTS

Preferred embodiments of the present invention will now be described with reference to the accompanying drawings.

First Embodiment

The first embodiment of the present invention relates to a dispenser which has a configuration to transmit identification information for specifying the liquid to be discharged as electromagnetic waves, an array thereof, a manufacturing method thereof, and an inspection method and a device using the dispenser.

(Dispenser and Manufacturing Method for Dispenser)

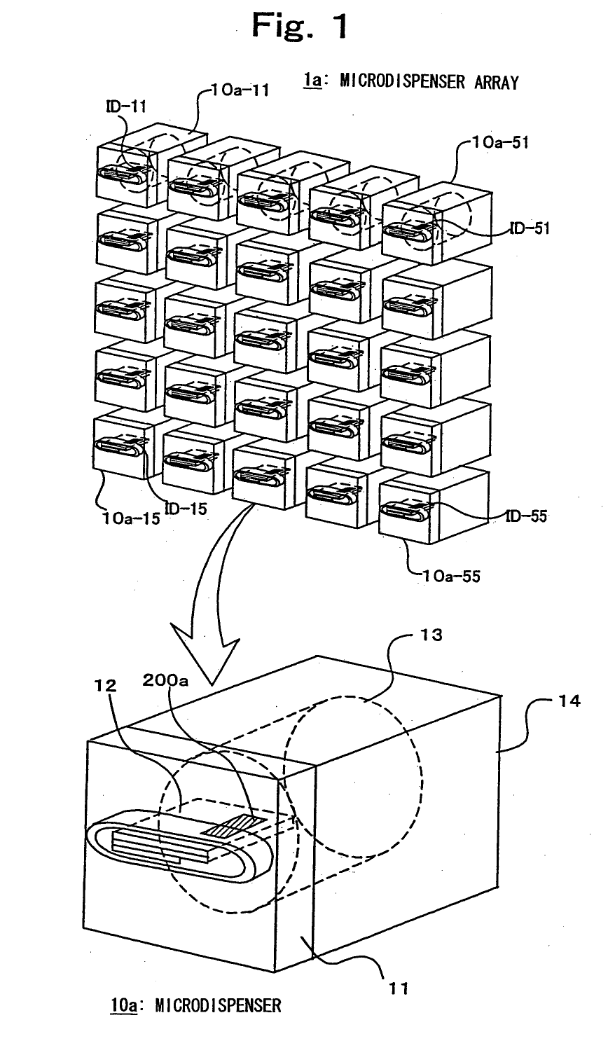

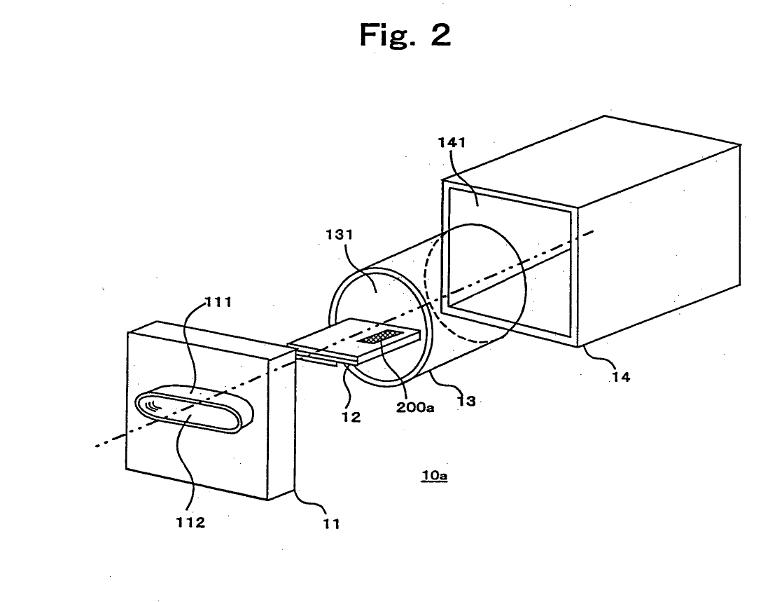

FIG. 1 and FIG. 2 are perspective views depicting the structure of the dispenser (cartridge) and the dispenser array according to the first embodiment. The dispenser 10a according to the first embodiment relates to a dispenser which is constructed such that the identification information can be transmitted, particularly as electromagnetic waves.

As FIG. 1 shows, the dispenser array 1a is comprised of a plurality of dispensers 10a being arrayed. FIG. 1 is an example when a total of 25 dispensers 10a are arrayed in a 5 column×5 row matrix structure. Each dispenser 10a is structured such that liquids which contain a different biopolymer can be discharged. The number of rows and columns in the dispenser array 1a and the total number of dispensers 10a are appropriately defined according to the number of types of liquid to be used, and the discharge quantity thereof. For the liquid for which quantity to be used is large, in particular, it may be structured such that a plurality of dispensers can discharge a same type of liquid. Each dispenser 10a comprises a structure (e.g. engaging element) for relative positioning with an adjacent dispenser 10a so that the pitch between the dispensers becomes accurate, although this is not illustrated. For example, the dispenser array 1a has an array structure where each dispenser is placed in a dispenser housing container, which is not illustrated.

As FIG. 2 shows, each dispenser 10a comprises a cover 11, head chip 12, tank 13 and case 14. The cover 11 has a discharge outlet 111 which has an opening 112. The head chip 12 is a layered substrate structure, which has an electrostatic drive type head structure for discharging the liquid in the tank 13, where the identification information holding means 200a, for holding the identification information of the present invention, is disposed. The tank 13 is structured such that liquid to be discharged to the hollow section 131 can be stored. The case 14 houses the head chip 12 and the tank 13, and is bonded with the cover 11.

For the cover 11 and the case 14, material which can be easily molded, having an appropriate degree of strength and corrosive resistance to the liquid, such as various synthetic resins and various glass materials, can be used. For example, the cover 11 and the case 14 are molded with polyvinyl chloride (PVC). In particular, the material of the cover 11 and the case 14 must be a material which does not influence the identification information when the information is read. When electromagnetic waves are the transfer medium of the identification information, as seen in the first embodiment, for example, a composing material which does not contain a metal component must be chosen so that the electromagnetic waves are not affected. It is preferable to choose a composing material with high transparency, since the presence of a foreign substance can be visually seen from the outside. Particularly when light is the transfer medium of the identification information, as seen in the later mentioned second and third embodiments, it is necessary to choose a composing material with high transparency, so that light transmittance is not affected.

The tank 13 can be sealed with packing for sealing areas other than the filling inlet for filling the liquid and the supply outlet for supplying the liquid to the head chip 12, although this is not illustrated. The filling inlet of the sealing means is sealed after the liquid is filled into the hollow section 131. Since the filling inlet of the liquid is sealed in this structure, mixing with another solution is prevented when liquid containing bio-molecules is used, and the dispenser can be disposable. The material of the tank 13 is a material which has corrosive resistance to the liquid to be filled and elasticity for applying appropriate pressure on the liquid, and supplying it to the head chip 12, such as butyl rubber. To stably supply the liquid to the head chip 12 here, the liquid must be stored at a pressure lower than the atmospheric pressure (negative pressure). So if the tank is made of butyl rubber, for which the transmittance of gas and water vapor is low, pressure conditions can be satisfied while preventing the entry of gas and water vapor in and out of the tank, and the outflow of liquid. The tank 13 is structured without any substance which may affect the composition of the liquid, such as an additive contained in the composing material. The liquid capacity of the tank 13 is about 1 ml, for example.

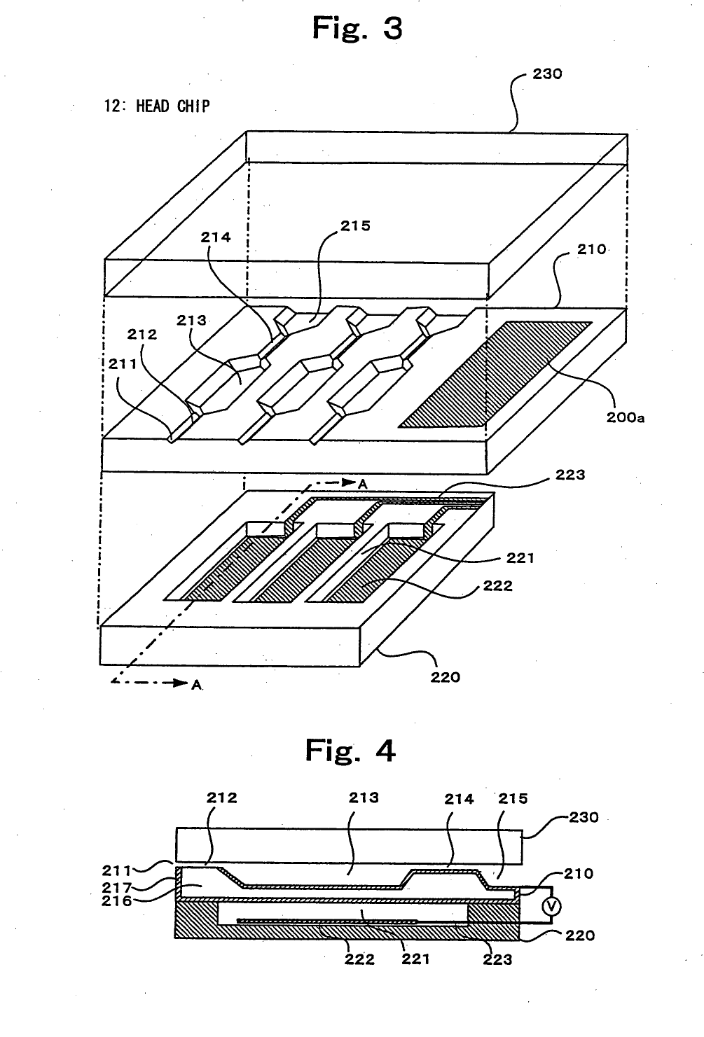

FIG. 3 shows an exploded perspective view of the head chip 12 according to the first embodiment, and FIG. 4 shows a cross-sectional view of the A-A cutting plane of the perspective view in FIG. 3.

The head chip 12 is comprised of a pressure chamber substrate 210, which is sandwiched by an electrode housing substrate 220 and a top substrate 230.

The pressure chamber substrate 210, where channel structures for discharging the liquid are created, further comprises the identification information holding means 200a according to the present invention. One channel structure is comprised of a nozzle 211, nozzle groove 212, pressure chamber 213, supply groove 214 and reservoir 215. In the pressure chamber substrate 210, an oxide film 217 is created on the surface of the silicon substrate main body 216, as shown in FIG. 4. The pitch of a channel structure is a pitch whereby liquid drops to be discharged do not mix, 0.5 mm, for example.

In the present embodiment, there are three lines of channel structures, but the number of channel structures to be disposed in one head chip may be adjusted according to the area and the specifications of the pressure chamber substrate.

For the material of the pressure chamber substrate 210, a material which has a predetermined rigidity, corrosive resistance to the liquid, and ease of micro-processing, is used, such as silicon substrate. Particularly in the case of the first embodiment, where a semiconductor circuit is used for the identification information holding means, it is preferable that the pressure chamber substrate 210 is made of silicon to which a semiconductor manufacturing process can be applied.

The electrode housing substrate 220 is a substrate for housing the electrode 222 for applying voltage in the electrostatic drive type head structure, wherein a concave section 221 is created at a position corresponding to each pressure chamber 213 when bonded with the pressure chamber substrate 210. In each concave section 221, an electrode 222 is created, and the wiring 223 is separately wired from each electrode 222. This wiring allows independent applying of voltage from the outside to an area between the electrode 222, corresponding to the pressure chamber, and the pressure chamber substrate 210, to be a common potential, as shown in FIG. 4. This voltage is applied in a predetermined pulse signal format as discharge drive signals from the inspection device. This electrode housing substrate 220 is selected considering a predetermined rigidity, ease of micro processing, price and visibility, for which silicon and various glass materials (e.g. boroslicate heat resistance hard glass), for example, can be used.

The top substrate 230 is selected considering a predetermined rigidity, corrosive resistance to the liquid, price and visibility, for which various glass materials (e.g. boroslicate heat resistant hard glass) can be used.

In the above mentioned head chip 12, the pressure chamber substrate 210 is comprised of silicon substrate, so the identification information holding means 200a, which can be manufactured in similar manufacturing steps, is also created on the pressure chamber substrate, but the identification holding means 200a may be created on the electrode housing substrate 220 or on the top substrate 230. Details of the manufacturing method of the head chip 12 will be described later.

For the structure of the dispenser array according to the first embodiment, refer to the related document by the present applicant (“A low power, small, electrostatically-driven commercial inkjet head”, S. Kamisuki et al, 1998, IEEE, pp. 63-68).

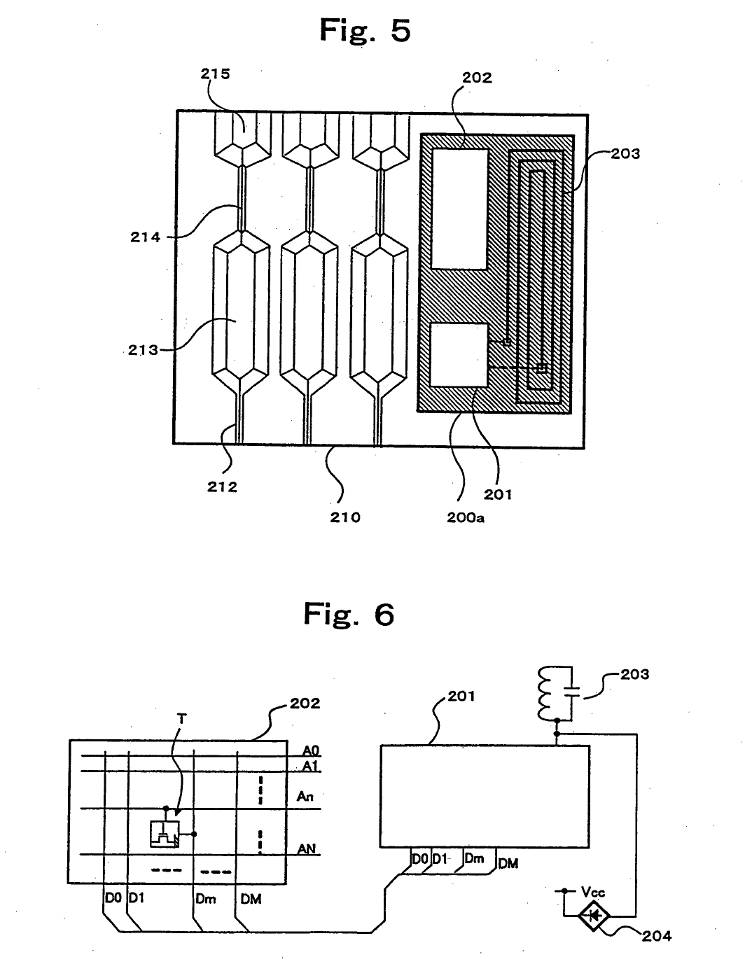

Now the configuration of the identification information holding means 200a according to the first embodiment will be described with reference to FIG. 5 and FIG. 6. FIG. 5 is a plan view of the head chip 12, and FIG. 6 is an electric block diagram of the identification information transmission circuit, which is the identification information holding means 200a.

The identification information holding means 200a according to the first embodiment is comprised of a control section 201, storage section 202, antenna 203 and power supply section 204. The blocks, excluding the antenna 203, are created in the creation area of the identification information holding means as one integrated circuit.

The storage section 202 has the configuration of an EEPROM (Electronically Erasable Programmable Read Only Memory). Each memory cell has a thin film transistor T which has a memory function. The capacity thereof is sufficient if a capacity sufficient for storing the identification information is available. In this storage section 202, a predetermined identification information is written to a predetermined storage area by a predetermined EEPROM write device when the dispenser is manufactured. The control section 201 is structured such that the identification information is read from the storage section 202, and the identification information is modulated with a predetermined frequency, and can be output as high frequency signals. This modulation frequency is, for example, a resonance frequency of the antenna 203. The antenna 203 is comprised of metal patterns created in a coil shape as electromagnetic tags, and constitutes the resonance circuit with the capacity means. The power supply section 204 is structured such that electromagnetic waves supplied from the outside are rectified, and sufficient power to drive the circuit for a predetermined time, such as several minutes, can be stored. Therefore this identification information transmission circuit operates when DC current is supplied when electromagnetic waves are emitted near the antenna 203.

In the above configuration, when electromagnetic waves for the power supply are supplied from the outside and operation of the circuit starts, the control section 201 starts operation, reads the identification information regularly from the storage section 202, generates pulses according to the read identification information, modulates the pulses with the carrier wave defined by the resonance frequency of the antenna 203, and outputs it as electromagnetic waves. This identification information is repeatedly output as long as power is supplied.

The above mentioned storage section 202 is structured so as to be programmed during manufacture, but may be structured such that by using such storage means as a non-volatile RAM, instead of ROM, the identification information can be non-periodically updated according to the radio waves for updating identification information from the outside. To make updates of the identification information possible, the storage section 202 is comprised of a writable memory, the control section 201 includes a microcomputer, and high frequency signals received from the antenna 203 are modulated so as to recognize the new identification information.

Identification information can be updated non-periodically by disposing an ON/OFF possible bit switch corresponding to the identification information in the identification information holding means. This bit switch may be a manual micro-switch or may have a configuration where dots corresponding to bits can be printed by an inkjet system, as stated in Japanese Patent Application Laid-Open No. 2002-104626.

The manufacturing method for the dispenser according to the present embodiment will now be described.

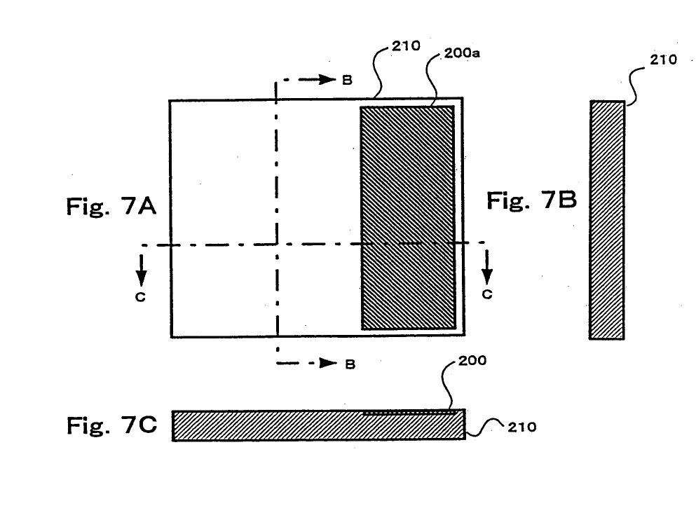

FIG. 7 to FIG. 11 shows the pressure chamber substrate 210 and other composing elements in each manufacturing step, wherein FIG. 7A is a plan view, FIG. 7B is a cross-sectional view of the B-B cutting plane in the plan view, and FIG. 7C is a cross-sectional view of the C-C cutting plane in the plan view.

As FIG. 7 shows, the semiconductor device corresponding to the identification information holding means 200a is manufactured first. On the silicon mono crystal substrate (e.g. (100) plane orientation), such as a silicon wafer, patterns for implementing a semiconductor device, with the circuits and layout shown in FIG. 5 and FIG. 6, are created in the identification information holding means creation area in each head chip 12 creation area. For the semiconductor device manufacturing method, a known technology, such as a photolithography method or an ink jet method, can be applied.

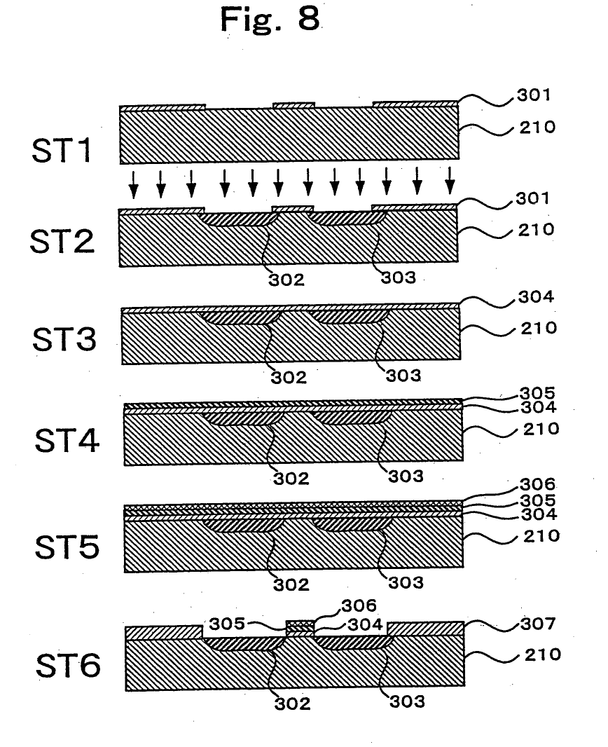

FIG. 8 shows the semiconductor device manufacturing method using the thin film transistor T, constituting the memory cell of the storage sector 202, as an example. This thin film transistor T has a general MNOS (Metal Nitride Oxide Silicon) structure as an example of an EEPROM. Of course another memory structure which can hold information semi-permanently can also be used.

As ST1 shows, an n-type impurity is diffused in the substrate 210, or an n-type well is formed, and on the surface, SiO₂ is deposited to form the oxide film 301. To form the oxide film, a known method, such as a vapor deposition method including a plasma chemical vapor deposition (PECVD) method, low pressure chemical vapor deposition (LPCVD) method, and a sputtering method, is used. For example, by using the PECVD method, a 1 μm thick oxide layer 301 is formed. Then openings are created in the insulation film 301 at the parts to be the drain region and the source region of the thin film transistor by a known method, such as a photolithography method.

Then as ST2 shows, an impurity ion to be the donor or acceptor is implanted to form the source region 302 and the drain region 303. In other words, using the oxide film 301 formed between the channel region and the device, a p-type impurity, such as boron, is doped and the p-type source region 302 and the drain region 303 are formed. For example, to fabricate this MNOS transistor, phosphorous (P) is implanted, as an impurity element, into the source/drain region at a predetermined concentration, 1×10¹⁶ cm⁻², for example. Then the impurity element is activated by applying appropriate energy, such as irradiating an XeCl excimer laser with an irradiation energy density of about 200 to 400 mJ/cm², or annealing at a temperature of about 250° C. to 450° C.

Then as ST3 shows, the oxide film 301 is removed first, and the insulation film 304 is formed again using SiO₂ on the entire surface of the substrate 210. This insulation film is also formed using a known technology, as mentioned above. This insulation film 304 is formed to be extremely thin to inject electric charges into the silicon nitride film 305 by causing a tunnel phenomenon. For example, a 10-20 Å thick insulation film 304 is formed using the PECVD method.

Then as ST4 shows, the silicon nitride film 305 is formed on the insulation film 304. For the silicon nitride film, the above mentioned oxide film 301 formation method can be applied. For example, a 1 μm thick insulation layer 304 is formed by the PECVD method.

Then as ST5 shows, the metal film 306 for a gate electrode is formed on the silicon nitride film 305. For example, tantalum or aluminum metal thin film is formed by a sputtering method.

Then as ST6 shows, the layer structure of the insulation film 304, silicon nitride film 305 and metal film 306 is removed by dry etching, while the gate electrode pattern on the channel region remains. Also as a device isolation layer, an oxide film 307, such as SiO₂, is formed by a known method and is patterned. For example, about a 500 nm thick oxide film 307 is formed by the PECVD method. And a layer insulation film, which is not illustrated, is formed, and then after creating contact holes to the source region 302 and the drain region 303, a metal layer for interconnects is formed, and the interconnect pattern is created.

In the thin film transistor T having this MNOS structure, if a programming voltage, more than a predetermined potential, is applied to the gate electrode 306 in a status where the source region 302 is connected to the ground potential and the drain region 303 is connected to the power supply, the oxide film 304 causes a tunnel phenomena, and electric charges are injected into the silicon nitride film 305. When electric charges are injected into the silicon nitride film 305, the threshold voltage changes and the silicon nitride film can have a memory function. If a predetermined voltage with a reverse polarity is applied to the gate electrode of the thin film transistor where electric charges have been injected, the electric charges stored in the silicon nitride film 305 are released, and the memory is erased.

Similar semiconductor manufacturing steps are also applied to the control section 201 and the power supply section 204, and semiconductor circuits which operate in a predetermined procedure are created. For the antenna 203, a conductive coil pattern is created with a metal thin film, and the circuit elements of a capacitor are created, then through holes are created to electrically connect with the control section 201.

The identification information holding means 200a can be created by the above steps, but such a semiconductor device can be created in various ways applying known technologies.

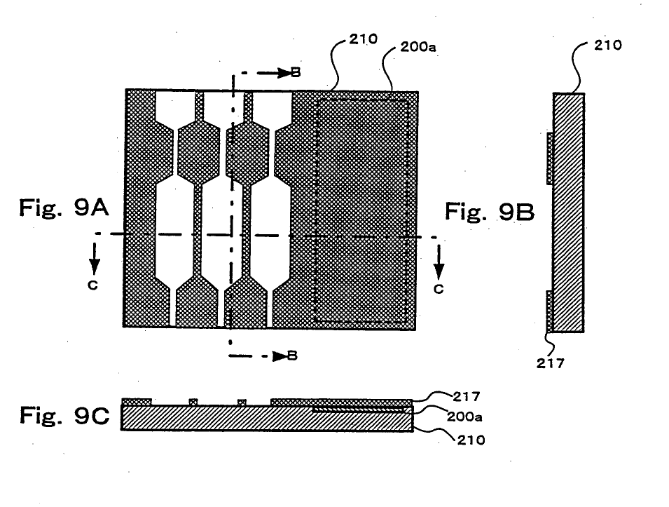

Then, as FIG. 9 shows, the oxide film 217 is formed to create the channel pattern. For example, TEOS (tetraethylorthosilicate, Si(OC₂H₅)₄)), with which a good quality film can be obtained at a relatively low temperature, is formed by CVD, and then the oxide film 217, where the patterns of the channel pattern are opened, is formed using a photolithography method.

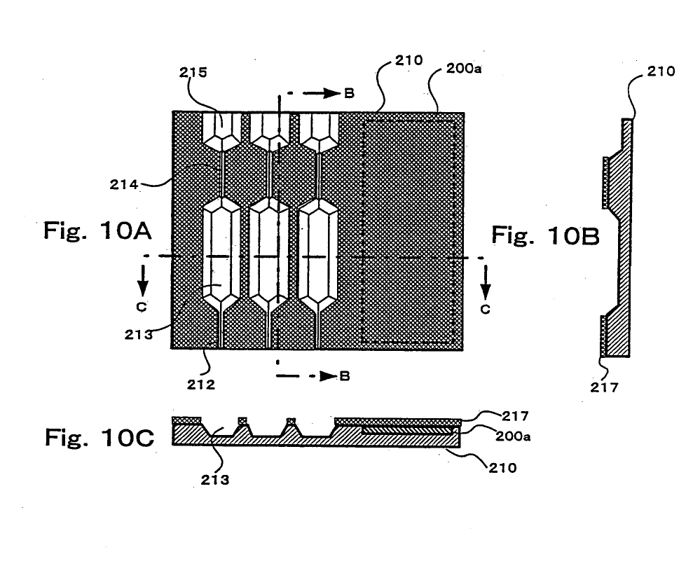

Then as FIG. 10 shows, etching is performed to create a channel structure, including the pressure chambers. For example, with a TMAH (tetramethylammonium hydroxide) solution, which is organic and a strong alkali, three-dimensional etching is performed using the anisotropy of silicon mono-crystals. In other words, in a silicon mono-crystal substrate with a (100) plane orientation, the etching speed on the (111) plane is the slowest, so this plane remains as a smooth plane in the etching process. This (111) plane forms about a 55° angle from the (100) plane, so etching is performed so that the substrate plane and the wall plane to be etched forms this angle by anisotropic etching. By managing the time for performing etching, etching can be performed so that the thickness of the diaphragm portion at the bottom face of the pressure chamber 213 becomes a predetermined thickness, 13±3 μm, for example.

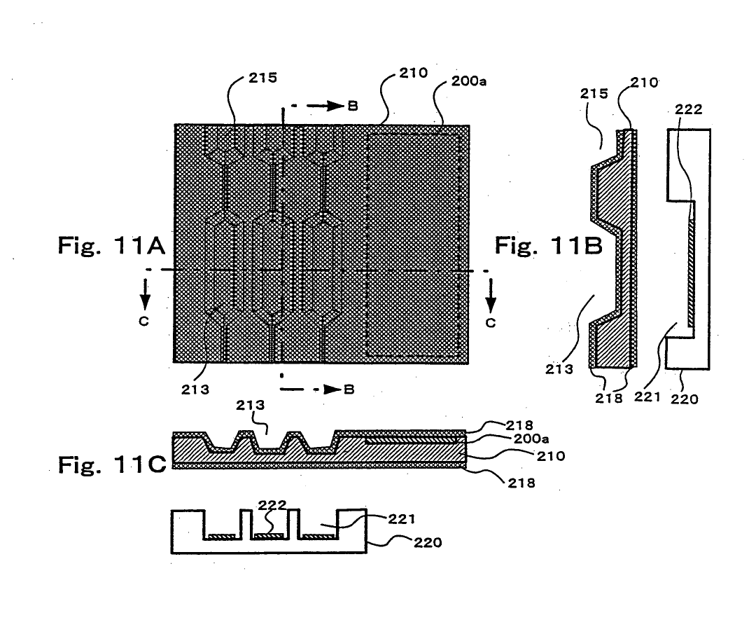

Then after the oxide film 217 is stripped off, the oxide film 218 is formed again on both sides of the silicon substrate, as shown in FIG. 11. For example, TEOS is deposited to be about a 0.05-0.2 μm thickness by the CVD method to form the oxide film 218 on both sides of the pressure chamber substrate 210. This oxide film 218 has a function to control the hydrophilic properties at the channel side of the pressure chamber substrate 210. In other words, while the liquid to be discharged is a solution containing protein and a base, the silicon substrate is hydrophobic, so the liquid would not be appropriately filled in the entire channel if the liquid were supplied as is. Therefore, if a hydrophilic oxide film is formed on the surface of the channel, as seen in the present embodiment, the channel structure changes to be hydrophilic, where the above problem does not occur. The oxide film 218 formed at the electrode housing substrate 220 side, on the other hand, plays a role as an insulation film.

In the above step, the channel structure is created after the identification information holding means 200a is created, but creating the identification information holding means and creating the channel structure have a common processing, such as silicon etching. So these two steps may be performed in parallel. If both steps are performed in parallel, the manufacturing time can be decreased, and all manufacturing steps can be simplified by integrating the semiconductor manufacturing process and the oxide film formation process for creating channels, for example.

Also as FIG. 11 shows, the electrode housing substrate 220 is created in parallel with the creation of the pressure chamber substrate 210.

At first, the concave sections 221 are created on the electrode housing substrate 220 corresponding to the positions of the pressure chambers 213. It is preferable to create the electrode housing substrate using a material with a high light transmittance, so as to make a foreign substance check and operation check easier. For example, a predetermined glass substrate, such as Pyrex glass, is used for the electrode housing substrate, and the concave sections 221 are created on this glass substrate with a predetermined depth, such as about 0.3 μm. The depth of the concave sections 221 are defined to a degree with which an electrostatic force appropriate for transforming the diaphragm can be applied. Then electrodes 222 are created inside the concave sections 221. In the case when the electrode housing substrate is created with a relatively transparent material, it is preferable to create the electrodes using such a transparent electrode material as ITO (Indium Tin Oxide). To create the electrodes 222, rather than a photolithography method to create the electrodes 222 on the entire surface and removing unnecessary portions, an inkjet method of filling the transparent electrode material in concave section 221 and drying may be used. Then the interconnect 223, for supplying drive signals from outside the head chip 12 to the electrodes 222, is created. To create the interconnect 223, metal film is formed and patterned by a photolithography method. The interconnect 223 may be patterned simultaneously when the electrodes 222 are created.

Then the pressure chamber substrate 210 is bonded to be sandwiched by the electrode housing substrate 220 and the top substrate 230. It is preferable that the top substrate 230 is created with a material with a high light transmittance, so as to make a foreign substance check and operation check easier. For example, a predetermined glass substrate, such as Pyrex glass, with about a 0.1-1 mm thickness, is used for the top substrate. The substrates can be bonded using various adhesives, but anode bonding is preferable. This is because anode bonding, which does not use adhesive, increases durability, and causes less possibility that components of adhesive influence the liquid containing bio-molecules or are influenced by the liquid containing bio-molecules. In the case of anode bonding, these three substrates are stacked with alignment first, then are heated at a predetermined temperature, 300° C. for example, and a predetermined voltage, such as 500V. DC voltage, is applied for a predetermined time, such as five minutes, using the pressure chamber substrate 210 as an anode and the electrode housing substrate 220 and the top substrate 230 as a cathode. In the pressure chamber substrate 210, an integrated circuit of the identification information holding means 200a has been created, so it is preferable to take safety measures, such as shorting each element of the control section 201 and the storage section 202 constituting the integrated circuit, so as not to destroy the substrate by the strong electric field caused by anode bonding. In the same way, it is preferable to take such a safety measure as grounding the terminal for the antenna 203 as well, so that excessive potential is not generated. After anode bonding is performed, processing for preventing foreign substances from entering inside is performed, such as sealing each part of the head chip. After the above processing, the wafer is cut and separated into each head chip 12.

The present embodiment was described using an electrostatic drive type head structure as an example, but the present invention may comprise a piezo drive type or a thermal drive type head structure.

By the above steps, the head chip 12 shown in FIG. 3 and FIG. 4 can be manufactured. This head chip 12 is connected to the tank 13 by packing, and is sealed by the cover 11 and the case 14, as shown in FIG. 2, then the dispenser 10 is completed.

As FIG. 1 shows, the dispenser array 1 can be constructed by arranging and securing a predetermined number of dispensers 10 at a predetermined pitch using a housing container, which is not illustrated.

(Inspection Device and Inspection Method)

Now an inspection device, which comprises this dispenser array and is used for inspecting and manufacturing biochips, will be described. The inspection device according to the first embodiment is constructed such that electromagnetic waves, for indicating identification information which is output from the dispenser 10, are received, and the identification information indicated by the electromagnetic waves can be recognized.

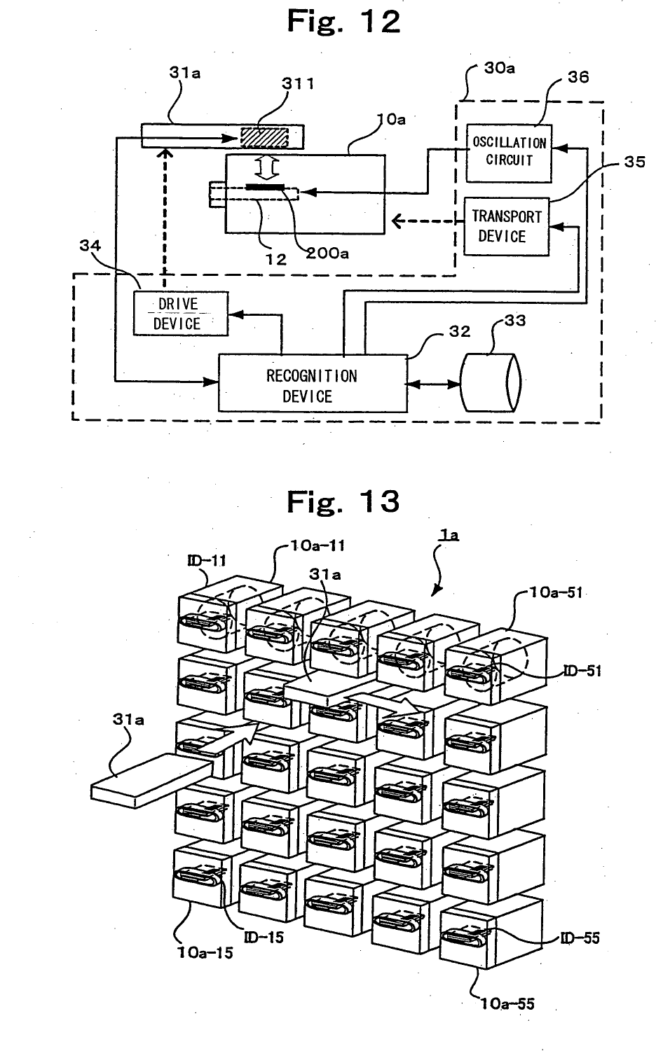

As FIG. 12 shows, this inspection device 30a comprises a sensor 31a, recognition device 32, storage section 33, drive device 34, transport device 35 and oscillation circuit 36.

The sensor 31a has a coil 311 which detects electromagnetic waves, including the identification information, and outputs electric signals corresponding to the identification information. The recognition device 32 is structured such that the identification information can be recognized by demodulating the high frequency signals by the coil 311. The storage section 33 is structured such that the recognized identification information can be stored corresponding to the position of each dispenser 10a. According to the information stored in this storage section 33, liquid containing bio-molecules is discharged to the biochip. The drive device 34 is structured to drive the sensor 31a to the position where the electromagnetic waves from any dispenser 10a from the dispenser array 1a can be received. The transport device 35 is structured such that the dispenser 10a, corresponding to the identification information recognized by the recognition device 32, can be transported to a predetermined discharge position based on that identification information. The oscillation circuit 36 is structured such that after the transport device 35 transports the dispenser 10a to an applicable position, the drive pulse with a predetermined frequency, such as a 30 kHz frequency, can be output between each electrode 222 and the pressure chamber substrate 210 in the head chip 12.

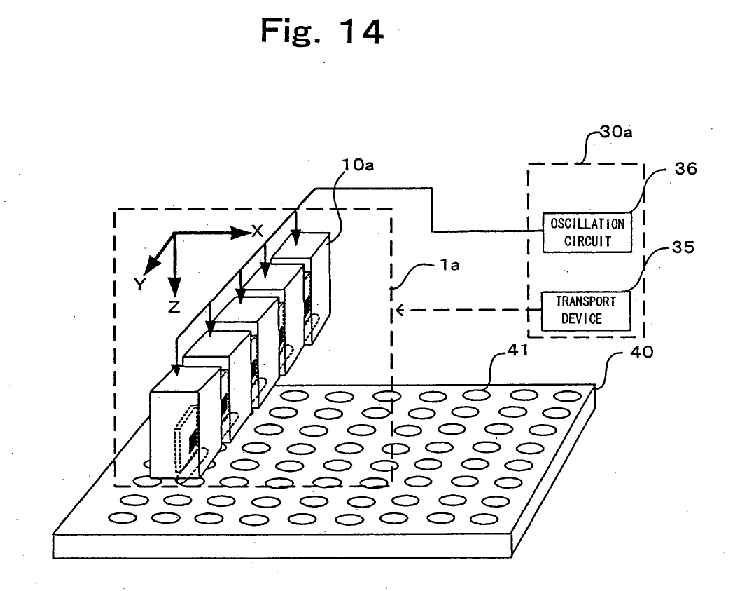

FIG. 13 shows the driving of the sensor 31a for reading the identification information from the dispenser array 1a according to the first embodiment.

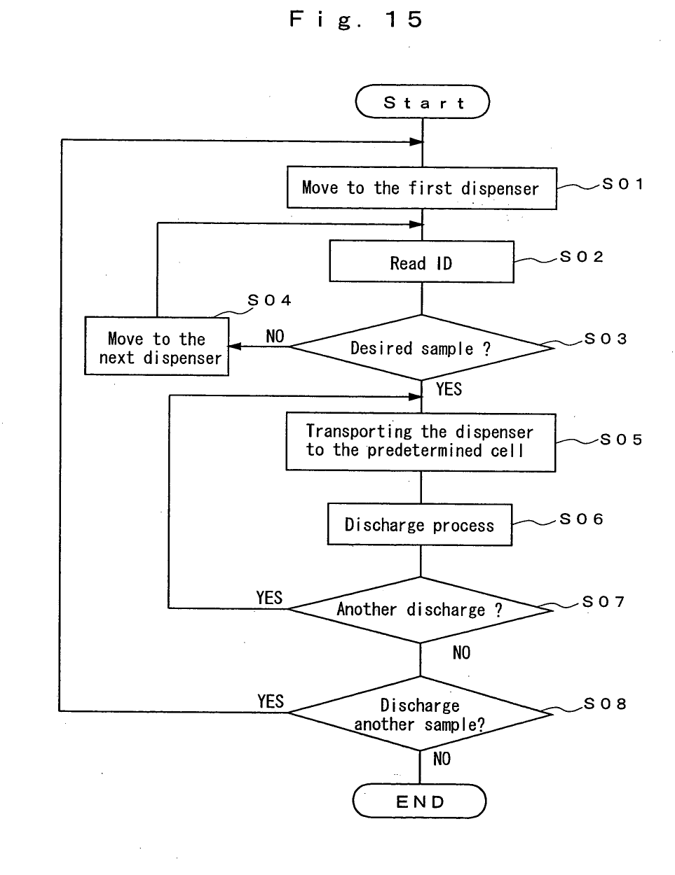

According to the first embodiment, the electromagnetic waves, which indicate the identification information, can be detected near each identification information holding means, so the identification information can be read only if the sensor 31a is disposed near the dispenser 10a, without accurately adjusting the positional relationship between the sensor and the dispenser. In other words, when the sensor 31a approaches a predetermined dispenser 10a by the drive device 34, the electromagnetic waves being output from the coil 311 are received by the antenna 203 of the identification information holding means 200a of this dispenser 10a, and the power supply device 204 supplies the power required for the circuit operation to the identification information holding means. In the identification information holding means 200a, the control section 201 reads the identification information stored in the storage section 202 regularly, and outputs it from the antenna 203 as high frequency signals. The coil 311 of the sensor 31a receives these high frequency signals, and outputs them to the recognition device 32 as electric signals. The recognition device 32 stores the identification information contained in the electric signals in the storage section 33 if necessary, as shown in FIG. 14, then specifies the discharge target position which is assigned so as to correspond to the identification information, and transports the dispenser 10a to this discharge target position using the transport device 35. The oscillation circuit 36 outputs the discharge drive signal to the head chip of the dispenser 10a transported to this discharge position. From this head chip 12, liquid, based on this discharge drive signal, is discharged.

The identification information and the information on the type of the liquid indicated by the identification information and the position where the liquid is discharged can be stored in the storage section 33 in advance.

Detailed operation of the inspection method to be executed by the inspection device 30a will now be described with reference to the flow chart in FIG. 15.

The inspection device 30a first moves the sensor 31a to one dispenser 10a of the dispenser array 1a (S01). And recognizes the identification information which is received by the coil 311 in the sensor 31a (S02). The inspection device also judges whether this identification information is an identification number corresponding to the discharge target liquid (S03). If the liquid specified by this identification information is not a discharge target (S03: NO), the inspection device drives the sensor 31a to the next dispenser 10a, and receives the identification information in the same way (S02-S03). If the liquid specified by the recognized identification information is the discharge target (S03: YES), the inspection device transports the dispenser 10a onto the corresponding well 41 on the plate 40 to which the liquid specified by the identification number is discharged (S05), and outputs the discharge drive signal to the area between the pressure chamber substrate 210 of the head chip 12 and the electrode 222 via the oscillation circuit 306, as shown in FIG. 14. In the pressure chamber 213 to which voltage is applied, the diaphragm at the bottom section thereof is bent by the electrostatic force due to this voltage, and liquid is discharged from the nozzle 211 because of the volume change in the pressure chamber 213 caused by this bending (S06).

After one discharge processing ends, it is checked whether it is registered that the discharged liquid is also discharged to another well 41, and if registered (S07: YES), the dispenser 10a is transported to the position of this well 41 (S05) and discharge processing is continued (S06).

When discharge of the liquid specified by the identification information is ended and it is necessary to discharge a liquid containing other biopolymers (S07: YES), on the other hand, the sensor 31a is transported to near the other dispenser 10a, the identification number is recognized, and discharge processing, when the liquid specified by this recognition number is liquid to be discharged, is performed (S02-S07).

By the above processing, discharge to an appropriate well 41 on the plate 40 is completed for the plurality of dispensers 10a constituting one dispenser array 1a.

According to the first embodiment, the liquid to be discharged from the dispenser can be identified by recognizing the identification information. Therefore liquid to be discharged from the dispenser can be recognized and discharged for the biochips which use various kinds of polymer materials, and the liquid can be discharged with certainty and accuracy.

Particularly according to the first embodiment, the identification information holding means has a configuration which can transmit electromagnetic waves to indicate the identification information to be held, so the identification information can be detected and identification information can be easily acquired without accurate alignment for reading the identification information, in other words, even in a non-contact status by merely moving the sensor near the dispenser. For example, even if the dispenser array has a structure where the sensor cannot intervene between dispensers, identification information can be acquired by the identification information holding means.

According to the first embodiment, the identification information holding means is structured such that the identification information is stored in the storage section and can be read, so relatively complicated identification information can be supported. In other words, for the identification information, not only specifying the type of the liquid, but such related information as composition of the liquid, composition of the solvent and the solute, quantity of the liquid, storage and use conditions, specified information of the manufacturer (name, address, contact number), manufacturing number, person-in-charge and manufacturing date, can be stored.

According to the first embodiment, it is preferable to structure the identification information holding means such that the identification information can be updated, because identification information can be changed to the identification information matching the liquid each time new liquid for discharge is filled, which makes reuse of the dispenser possible. In other words, the identification information can be updated each time liquid is refilled into the dispenser.

According to the dispenser array of the first embodiment, the liquid discharged from an individual dispenser can be recognized with certainty and accuracy using the identification information, even if various kinds of liquids are discharged from each dispenser, so error does not occur.

According to the inspection device of the first embodiment, the liquid to be discharged from the dispenser can be specified by the recognition device recognizing the identification information, so the dispenser can be transported to an appropriate position where the specified liquid is discharged, and then the liquid is discharged. Therefore the liquid for each dispenser can be discharged with certainty and accuracy to the corresponding position. Particularly if the present invention is applied to a dispenser array which is structured to allow the discharge of various kinds of liquids, the target liquid can be discharged to the appropriate position one after another in a short time.

According to the inspection device of the first embodiment, the sensor is moved to the detectable position of any dispenser, so in the dispenser array which is structured to allow the discharge of various kinds of liquids, the sensor can be moved to a correct detection position without using human hands.

In the biochip to which liquid is attached by the inspection device according to the first embodiment, polymer material can be attached at high-speed, with certainty and accuracy by the inspection method of the present invention, so biochips which manufacturing unit price is low can be provided.

<Second Embodiment>

The second embodiment of the present invention relates to a dispenser having a structure that influences the reflection of light, instead of the configuration of the first embodiment, where electromagnetic waves in the identification information holding means are output.

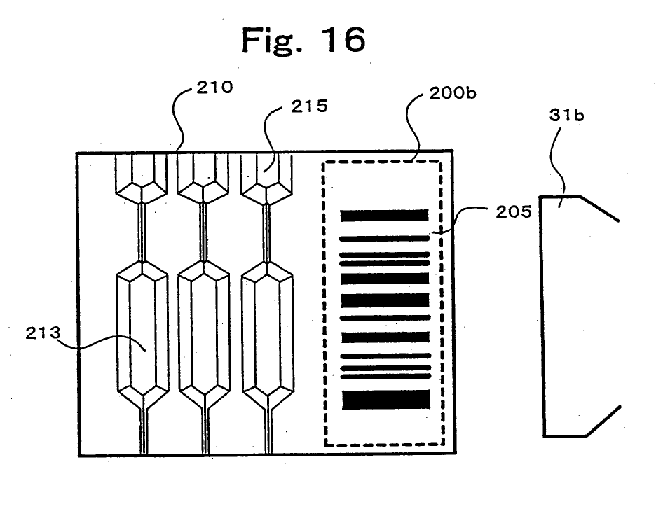

FIG. 16 is a plan view depicting the pressure chamber substrate 210 in the head chip of the dispenser 10b according to the second embodiment. Descriptions on the configuration, other than the identification information holding means, which are the same as the first embodiment, are omitted.

As FIG. 16 shows, the identification information holding means 200b in the present embodiment is a so called barcode, where identification information is coded according to a predetermined standard, and character information is defined by the width and space of black lines.

Here “barcode” refers to the means of automatic recognition, where the alphabet, numerics and symbols are replaced with one-dimensional black and white patterns (actually two-dimensional since width is involved) according to a predetermined algorithm, so as to be digitally input to a computer. The code system of the barcode is classified into a binary level and multi level. Binary level code is a code comprised of two types of bar widths, a narrow bar and a wide bar, where detailed code systems, such as CODE-39, CODABAR and various 2 of 5 barcodes exist. Multi level code is a code which has many types of widths of black and white bars, wherein such code systems as EAN, CODE-93 and CODE-128 exist. In these code systems, patterns to indicate the start and stop of the barcode are defined, and patterns corresponding to an arbitrary code fill between the start and stop of the barcode. In the barcode 205 in the present embodiment, patterns may be defined according to such code systems, or patterns may be based on an originally defined system. Parity to prevent error reads may be added in the barcode 205.

The barcode 205 is created in the identification holding means creation area of the pressure chamber substrate 210. The barcode 205 must be created such that the barcode reader 31b can read the code. In other words, it is preferable that the reflectance of the light differs as much as possible between the surface of the substrate and on the lines of the barcode 205.

The possible ways of creating a barcode are various printing methods, creating a thin film, gluing a label, and creating concave sections. To use a printing method, black dye or pigment is attached on the surface of the substrate, so that the barcode is printed on a document or product. After printing it is preferable to perform coating using a known technology so that the dye or pigment will not wear off. It is also possible to print a barcode pattern by an inkjet printing method. To use a method of forming a thin film, a metal film of which the light reflectance is low compared with the substrate, such as chrome, is formed and then is molded onto the bar code pattern. To use a method of gluing a label, the barcode 205 is printed on the label in advance, and the label is glued on the surface of the substrate using adhesive. To use a method of creating concave sections, the concave sections are created by etching barcode shapes in parallel with creating a channel structure on the surface of the substrate. By creating these concave sections, the reflection at the barcode portions becomes different from the surrounding area, which allows the barcode to function as a barcode. It is also acceptable that the concave sections are created first and then material with low reflectance, such as black dye or pigment, is filled into the concave sections.

The barcode 205 may be created on the top substrate 230 or on the electrode housing substrate 220, rather than the pressure chamber substrate 210.

The dispenser 10b comprising this identification information holding means 200b according to the present embodiment are integrated into the dispenser array 1b, which becomes a part of the inspection device 30b, just like the first embodiment. The inspection device according to the present embodiment is the inspection device 30a according to the first embodiment shown in FIG. 12, further comprising the barcode reader 31b, instead of the sensor 31a. This bar code reader 31b is transported just like the inspection method according to the first embodiment, so that the barcode 205 of each dispenser 10b can be read. Particularly in the present embodiment, the barcode reader 31b must be transported to a position where the barcode 205 of each dispenser 10b can be read with certainty.

As described above, according to the second embodiment, in addition to the same effect as the first embodiment, the identification information can be recognized with certainty in a range where light from the holding means reaches, and the identification information can also be visually recognized.

Also according to the second embodiment, the identification information holding means comprises a barcode, and the inspection device reads the identification information using the reflection of light, so the identification information can be recognized in a non-contact status. Barcode in particular can add identification information merely by gluing a label or printing, so the manufacturing steps can be simplified.

Also according to the second embodiment, conventional barcode readers, which are widely available, can be used as a part of the recognition device of the present invention, so it is simple.

<Third Embodiment>

The third embodiment of the present invention relates to a dispenser having a structure that influences the transmittance of light, instead of the configuration of the first embodiment, where electromagnetic waves in the identification information holding means are output.

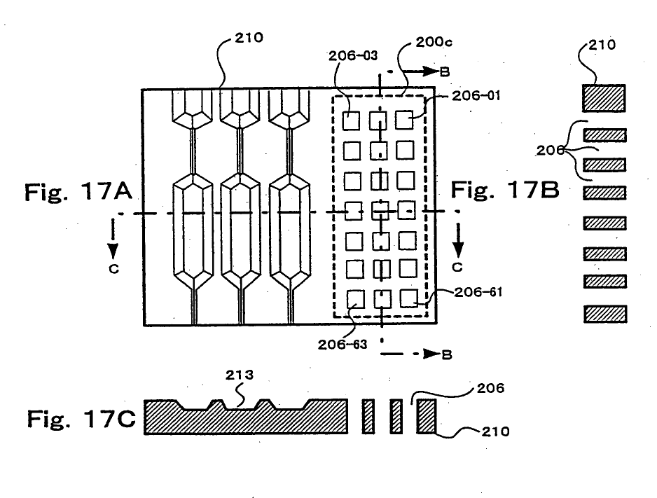

FIG. 17 is a plan view depicting the pressure chamber substrate 210 in the head chip of the dispenser 10c according to the third embodiment. Descriptions on the configuration, other than the identification information holding means, which are the same as the first embodiment, are omitted.

As FIG. 17 shows, the identification information holding means 200c in the present embodiment holds the identification information by the holes 206 created in the pressure chamber substrate 210. The encoding of the identification information, depending on whether the holes are open or not, can be set arbitrarily. FIG. 17 shows the case when all the holes 206 are open. The cross-sectional views in FIG. 17B and FIG. 17C show the status when oxide film is not formed.

If the total number of dispensers 10c to be identified is small, for example, it is possible to identify a dispenser merely by checking whether the hole is open at a predetermined position. If the hole is open at the position 206-01 in FIG. 17, then it can be judged that the liquid of this dispenser corresponds to the identification number “01”. In FIG. 17, 7 rows×3 columns, a total of 21 types of liquid, can be identified.

If the total number of dispensers 10c to be identified is more than the number of holes, then many liquids can be identified by encoding the array of the holes. For example, if the array of the holes is encoded by binary numbers, then 2²¹=2097152 types of liquid can be identified.

The holes 206 can be concave sections which have some depth, rather than through holes. If concave sections are used, then a sensor for detecting the presence of the hole using the change of reflected light must be disposed, as shown in the second embodiment.

Each hole 206 is created at a predetermined position corresponding to the identification information by a known method, such as dry etching. If the holes are created in parallel with the creation of the channel structure, then manufacturing can be simplified by sharing the manufacturing steps. If the concave section is used as a hole structure, then material with low reflectance, such as black dye or pigment, may be filled into the concave section.

The holes 206 may be created in the top substrate 230 or the electrode housing substrate 220, rather than the pressure chamber substrate 210.

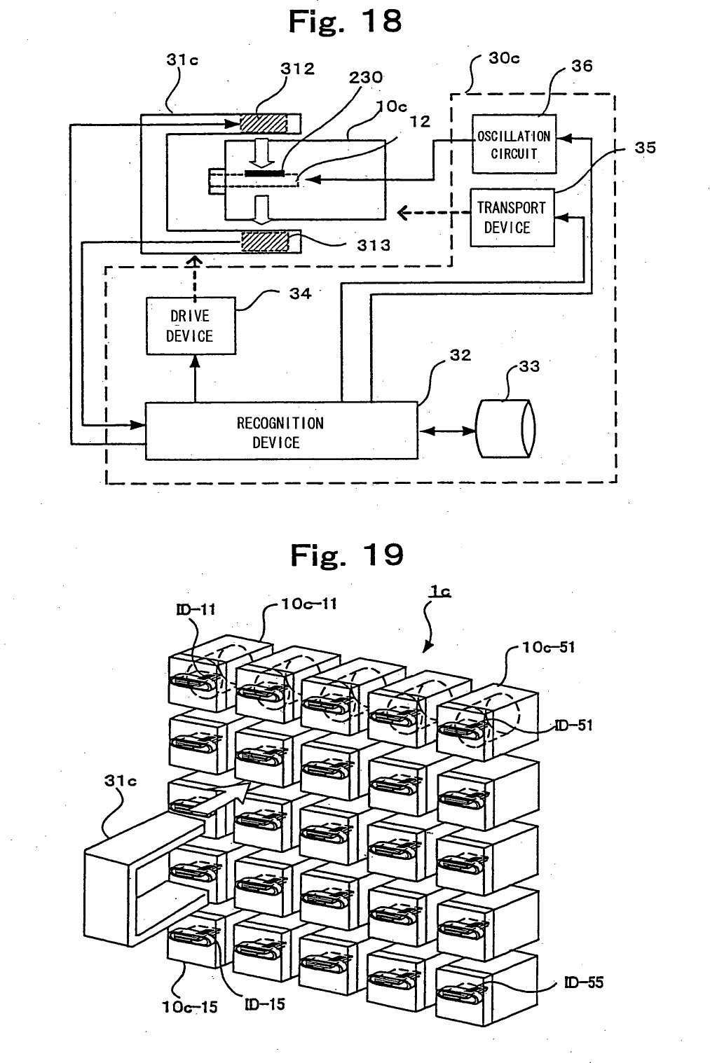

The dispensers 10c comprising the identification information holding means 200c according to the present embodiment in FIG. 18 are integrated in the dispenser array 1c, which becomes a part of the inspection device 30c.

As FIG. 18 shows, the inspection device 30c according to the third embodiment is an inspection device 30a according to the first embodiment, which has the sensor 31c comprising the light emitting section 312 and the light receiving section 313, rather than the sensor 31a. It is preferable that this sensor 31c has a squared C shape, for example, the dispenser 10c is inserted into this shape, and the path of light from the light emitting section 312 to the light receiving section 313 crosses vertically to the plane where the identification information holding means 200c is created. For this, it is preferable that the dispenser array 1c in the present embodiment has a space in the dispenser 10c, so that the sensor 31c can be inserted without a problem.

This sensor 31c is transported, just like the inspection method according to the first embodiment, so that the presence of the hole 206 of each dispenser 10c can be detected. Especially, in the present embodiment, as shown in FIG. 19, in order to read the presence of the hole with certainty, the sensor 31c must be transported to a position where the presence of the hole can be detected with certainty.

As described above, according to the third embodiment, in addition to the same effect as the first embodiment, the identification information can be recognized with certainty in a range where light can be transmitted to the holding means, and the identification information can be visually recognized.

As described above, according to the third embodiment, the identification information holding means has holes and the inspection device reads the identification information using the reflection of light, so the identification information can be recognized in a non-contact status.

<Fourth Embodiment>

The fourth embodiment of the present invention has a structure that influences the continuity of electricity, instead of outputting electromagnetic waves in the identification information holding means in the first embodiment.

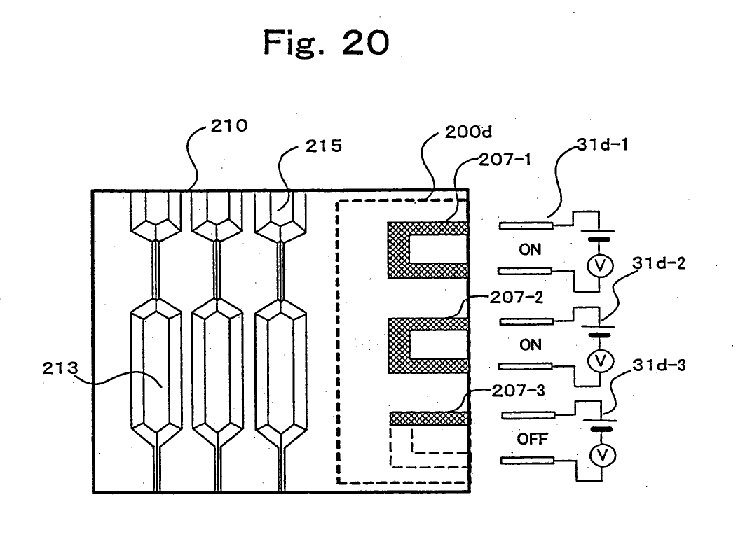

FIG. 20 is a plan view depicting the pressure chamber substrate 210 in the head chip of the dispenser 10d according to the fourth embodiment. Descriptions on the configuration, other than the identification information holding means, which are the same as the first embodiment, are omitted.

As FIG. 20 shows, the identification information holding means 200d in the present embodiment holds the identification information with a configuration which allows detection of the identification information by the continuity of electricity. For example, in the present embodiment, electrode patterns 207, where a terminal pair are electrically connected or disconnected, are created. And when an electrode pair (probe) is contacted to this terminal pair from the outside, the identification information is recognized depending on whether current flows between the electrode pair. Encoding of the identification information depending on the continuity of electricity can be set arbitrarily. For example, continuity or non-continuity of an electrode pattern is associated with a binary number, and a code system is set so as to represent the identification number as a power of 2. For example, in FIG. 20, three electrode patterns 207 exist, so a total of 2³=8 types of liquid can be identified. In FIG. 20 in particular, electrode patterns where electrode patterns 207-1 and 207-2 conduct and 207-3 does not conduct are shown.

For the creation of each electrode pattern 207, a known method, such as a photolithography method, can be applied. In other words, after the electrode film is created, a conductive pattern or a non-conductive pattern is created according to the identification information. If the electrode pattern 207 is created in parallel with the creation of the channel structure, manufacturing can be simplified since the manufacturing steps are shared.

This electrode pattern 207 may be created on the top substrate 230 and the electrode housing substrate 220 rather than the pressure chamber substrate 210.

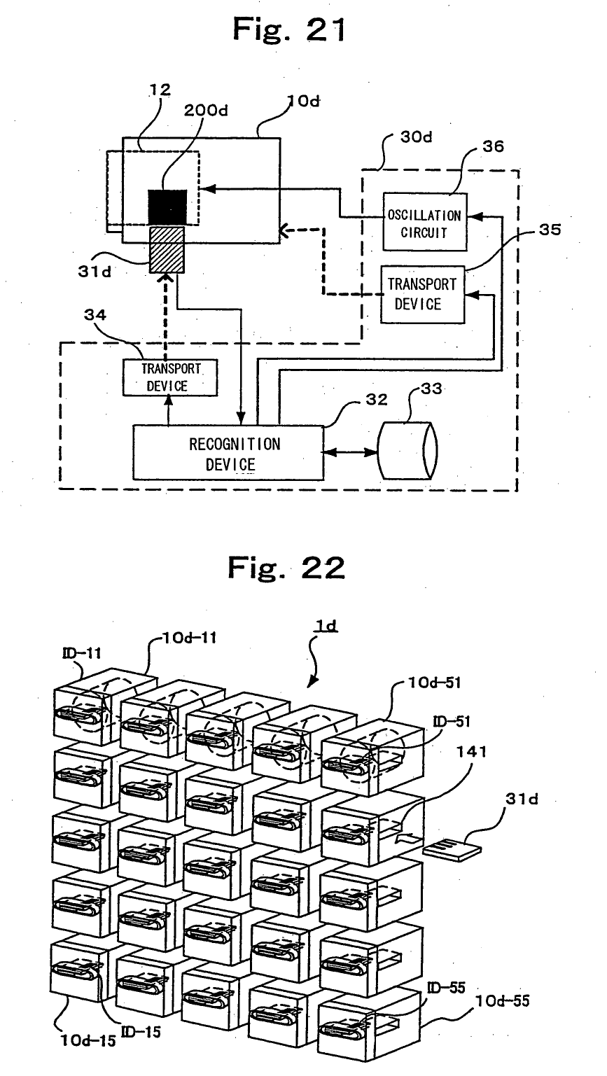

The dispensers 10d comprising the identification information holding means 200d according to the present embodiment shown in FIG. 21 are integrated into the dispenser array 1d, just like the first embodiment, and become a part of the inspection device 30d.

As FIG. 21 shows, the inspection device 30d according to the fourth embodiment is the inspection device 30a according to the first embodiment, further comprising a sensor 31d having electrode pairs 31d-1 through 31d-3 which are probes, instead of the sensor 31a. The terminal pair of the identification information holding means 200d requires electrical contact with the sensor 31d, so as FIG. 22 shows, it is preferable to create an opening 141 in the case 14 of the dispenser 10d, so that the sensor 31d is inserted, and is contacted to the terminal pair of the identification information holding means 200d. For this, the dispenser array 1d in the present embodiment preferably has a sufficient space between the dispensers 10d, so that the sensor 31d can be inserted into the dispenser 10d. If the terminal pair is created at the nozzle side of the pressure chamber substrate 210, however, the sensor 31d can be inserted from the discharge side of the dispenser.

This sensor 31d is transported, just like the inspection method according to the first embodiment, and can detect the electric continuity in each electrode pair in each dispenser 10d.

As described above, according to the fourth embodiment, identification information can be recognized with certainty in a range where the electrode pair can be electrically contacted to the holding means, in addition to the effect similar to the first embodiment, and identification information can also be visually recognized.

Also according to the fourth embodiment, the identification information can be recognized by a relatively simple detection method of checking the electric continuity.

<Fifth Embodiment>

The fifth embodiment of the present invention has a predetermined stereoscopic structure corresponding to the identification information to be held, instead of outputting electromagnetic waves in the identification information holding means in the first embodiment.

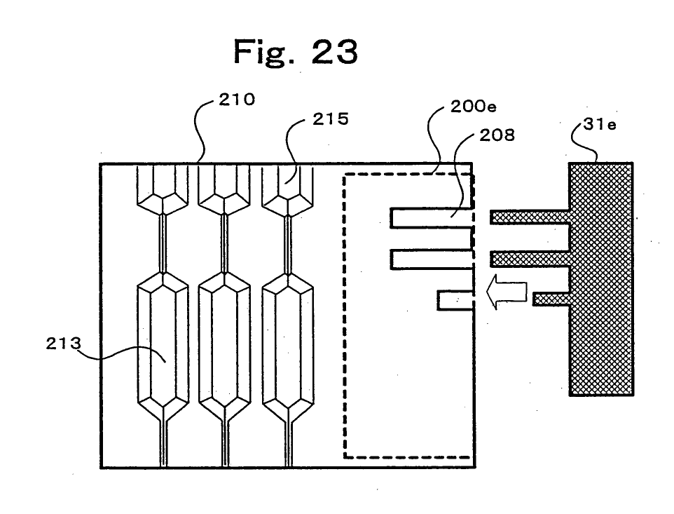

FIG. 23 is a plan view depicting the pressure chamber substrate 210 in the head chip of the dispenser 10e according to the fifth embodiment. Descriptions on the configuration, other than the identification information holding means, which are the same as the first embodiment, are omitted.

As FIG. 23 shows, the identification information holding means 200e in the present embodiment holds the identification information in the key seat structure 208. And the identification information is recognized depending on whether the key seat structure engages with the key 31e for identification information recognition to be inserted from the outside. The key seat structure 208 can be arbitrarily set, for which fine substrate processing is possible if a photolithography method is used, so the number amount of information to be recognized is enormous.

For the creation of each key seat structure 208, a known method, such as a photolithography method, can be applied. In other words, resist is created according to the key seat structure, and a stereoscopic structure can be created on the substrate or at the edge of the substrate by etching. If the key seat structure 208 is created in parallel with the creation of the channel structure, manufacturing can be simplified since the manufacturing steps are shared.

This key seat structure 208 may be created on the top substrate 230 or the electrode housing substrate 220, rather than the pressure chamber substrate 210.

The dispensers 10e comprising the identification information holding means 200e according to the fifth embodiment are integrated into the dispenser array 1e just like the fourth embodiment shown in FIG. 21, and becomes a part of the inspection device 30e.

The inspection device 30e according to the fifth embodiment is the inspection device 30d according to the fourth embodiment shown in FIG. 21, further comprising a key 31e, instead of the sensor 31d. This key 31e detects matching with the key seat structure 208, and can output the result to the recognition device 32. In the present embodiment as well, it is preferable to create an opening 141 in the case 14 of the dispenser 10e, as shown in FIG. 22, for example, so that the key 31e can be inserted into the key seat structure 208 of the identification information holding means 200e, just like the fourth embodiment. For this, the dispenser array 1e in the present embodiment preferably has a sufficient space between the dispensers 10e so that the key 31e can be inserted into the dispenser 10e. If the key seat structure 208 is created at the nozzle side of the pressure chamber substrate 210, however, the key 31e can be inserted from the discharge side of the dispenser.

This key 31e is transported, just like the inspection method according to the fourth embodiment, and can detect the engagement of the key in each dispenser 10e.

If the structure of the key 31e is constructed to be changeable according to the type of liquid to be identified, a plurality of types of dispensers can be identified. For example, if the length, width and position of the teeth and grooves of the key structure are structured to be changeable or a plurality of keys are selectively used, then a plurality of types of dispensers can be identified.

The stereoscopic structure in the present invention is not limited to the structure corresponding to a general concept of a so called key, but is sufficient if the structure can identify an individual dispenser by a feature of some stereoscopic structure.

As described above, according to the fifth embodiment, identification information can be recognized with certainty in a range where the key can be physically contacted to the holding means, in addition to the effect similar to the first embodiment, and identification information can also be visually recognized.

Also according to the fifth embodiment, the identification information can be recognized by fitting of a stereoscopic structure by inserting a key, so processing in the recognition device can be simplified.

<Other Modifications>

The present invention is not limited to the above mentioned embodiments, but can be modified and applied in various ways.

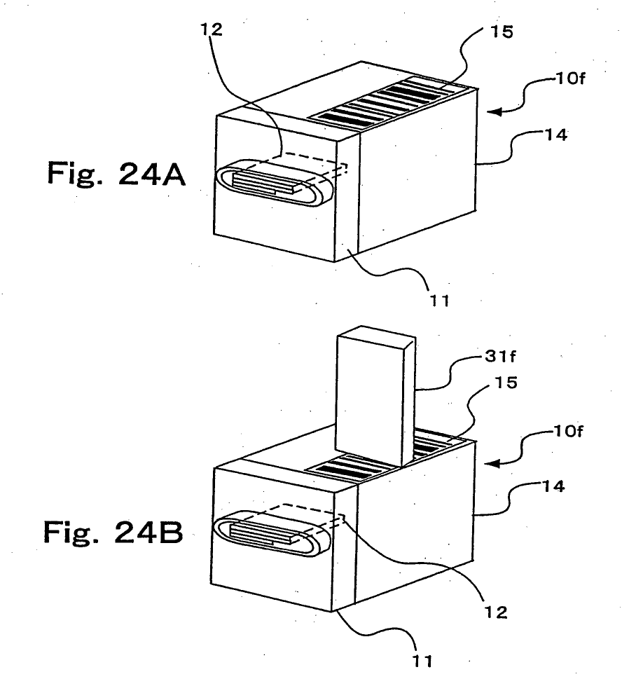

For example, the identification information holding means using optical reflection or transmission may be disposed at a location other than the head chip, such as a cover or a case. For example, FIG. 24A shows a case when a barcode 15, described in the second embodiment, is attached to the case 14 of the dispenser 10f. The barcode 15, printed on a label, may simply be glued on the case 14. If the barcode is attached on the surface of the body of the dispenser like this, then the barcode reader 31f can be easily approached to the barcode 15, as shown in FIG. 14B. Also a contact type barcode read, which reads code while contacting with and sliding onto the barcode, can be used.

In the same way, the identification information holding means for holding the identification information using an electrode pattern which indicates electric continuity, as in the fourth embodiment, may be disposed on the surface of the body of the dispenser. For example, an electrode pattern is created on the label by a conductive ink, and is glued at a predetermined location. By such a configuration, the identification information can be recognized merely by contacting the electrode pair on the body surface, without making openings in the body of the dispenser.

In the same way, the identification information holding means, with a stereoscopic structure shown in the fifth embodiment, may be created on the body surface of the dispenser. For example, the identification information can be recognized by creating such bumps as Braille in the process of resin molding or gluing a label on which bumps are created.

What is claimed is:

1. A dispenser comprising:
liquid discharge means for discharging liquid; and
identification information holding means for holding, in a readable manner, identification information for identifying said liquid.

2. The dispenser according to claim 1, wherein said liquid discharge means further comprises:
a tank for storing said liquid; and
a head chip for discharging said liquid stored in said tank.

3. A dispenser according to claims 1 or 2, wherein said identification information holding means has a configuration which is capable of transmitting electromagnetic waves for indicating said identification information to be held.

4. The dispenser according to claim 3, wherein said identification information holding means further comprises:
a storage section for storing said identification information;
a transmission section for transmitting said identification information; and
a control section for reading said identification information stored in said storage section and transmitting said identification information via said transmission section.

5. The dispenser according to claim 3, wherein said identification information holding means is constructed so as to be capable of updating said identification information.

6. The dispenser according to claim 4, wherein said identification information holding means is constructed so as to be capable of updating said identification information.

7. A dispenser according to claims 1 or 2, wherein said identification information holding means has a structure which influences the transmission or reflection of light, disposed corresponding to said identification information to be held.

8. The dispenser according to claim 7, wherein said identification information holding means further comprises a barcode or holes as said structure.

9. A dispenser according to claims 1 or 2, wherein said identification information holding means further comprises a structure which influences the electric continuity, disposed corresponding to said identification information to be held.

10. The dispenser according to claim 9, wherein said identification information holding means comprises, as said structure, an electrode pattern for conducting or non-conducting the electrode pairs for identification information recognition, which are contacted from the outside.

11. A dispenser according to claims 1 or 2, wherein said identification information holding means further comprises a predetermined stereoscopic structure corresponding to said identification information to be held.

12. The dispenser according to claim 11, wherein said identification information holding means further comprises, as said stereoscopic structure, a key seat structure for engaging with a key for identification information recognition, which is inserted from the outside.

13. A dispenser array comprising a plurality of dispensers as in claims 1, 2, 4, 5, 6, 8, 10 or 12, wherein said identification information for specifying said liquid stored in each dispenser is provided corresponding to each one of said dispensers.

14. A dispenser array comprising a plurality of dispensers according to claim 7, wherein said identification information for specifying said liquid stored in each dispenser is provided corresponding to each one of said dispensers.

15. A dispenser array comprising a plurality of dispensers according to claim 9, wherein said identification information for specifying said liquid stored in each dispenser is provided corresponding to each one of said dispensers.

16. A dispenser array comprising a plurality of dispensers according to claim 11, wherein said identification information for specifying said liquid stored in each dispenser is provided corresponding to each one of said dispensers.

17. A manufacturing method for a dispenser, comprising the steps of:
creating identification information holding means for holding identification information for identifying liquid at a predetermined area;
creating a liquid channel including a pressure chamber for applying pressure to said liquid on a pressure chamber substrate; and
creating applying means for applying pressure to said pressure chamber.

18. The manufacturing method for a dispenser according to claim 17, wherein said step of creating the identification information holding means is for creating a configuration which is capable of transmitting electromagnetic waves for indicating said identification information to be held, in said area.

19. The manufacturing method for a dispenser according to claim 17, wherein said step of creating the identification information holding means is for creating a structure which influences the transmission or reflection of light in said area corresponding to said identification information to be held.

20. The manufacturing method for a dispenser according to claim 17, wherein said step of creating the identification information holding means is for creating a structure which influences the continuity of electricity in said area corresponding to said identification information to be held.

21. The manufacturing method for a dispenser according to claim 17, wherein said step of creating the identification information holding means is for creating a predetermined stereoscopic structure in said area corresponding to said identification information to be held.

22. A manufacturing method for a dispenser as in claims 17, 18, 19, 20, or 21, wherein said step of creating the liquid channel further comprises the steps of
creating micro-channels including a nozzle for discharging said liquid; and
creating said pressure chamber and a reservoir.

23. A manufacturing method for a dispenser as in claims 17, 18, 19, 20, or 21, wherein the step of creating the applying means further comprises the steps of:
creating a concave section at a position corresponding to said pressure chamber on an electrode housing substrate to be connected with said pressure chamber substrate;
creating an electrode in said concave section; and
gluing said electrode housing substrate and said pressure chamber substrate.

24. The manufacturing method for a dispenser according to claim 22, wherein said step of creating the applying means further comprises the steps of:
creating a concave section at a position corresponding to said pressure chamber on an electrode housing substrate to be connected with said pressure chamber substrate;
creating an electrode in said concave section; and
gluing said electrode housing substrate and said pressure chamber substrate.

25. An inspection device, comprising:
a recognition device for recognizing identification information provided corresponding to a dispenser for discharging liquid;
a transport device for transporting said dispenser corresponding to said identification information to a predetermined discharge position based on said identification information recognized by said recognition device; and
a discharge control device for allowing said dispenser transported to said discharge position to discharge said liquid.

26. The inspection device according to claim 25, further comprising:
a sensor for detecting said identification information and outputting electric signals corresponding to said identification information; and
a sensor drive device for driving said sensor to a position where said identification information corresponding to one dispenser can be detected.

27. The inspection device according to claim 25, wherein said recognition device is constructed so as to be capable of receiving electromagnetic waves indicating said identification information of said dispenser, and regenerating said identification information indicated by said electromagnetic waves.

28. The inspection device according to claim 26, comprising, as said sensor, an antenna for receiving the electromagnetic waves which are output from the identification information holding means where said identification information is held.

29. The inspection device according to claim 25, wherein said recognition device is structured so as to be capable of detecting the received light and regenerating said identification information indicated by said light.

30. The inspection device according to claim 26, comprising, as said sensor, a light receiving section for receiving reflected light or transmitted light of the light which is irradiated toward the identification information holding means where said identification information is held.

31. The inspection device according to claim 25, wherein said recognition device detects the continuity or discontinuity of electricity and recognizes said identification information corresponding to said continuity or discontinuity of electricity.

32. The inspection device according to claim 26, comprising, as said sensor, a probe for detecting the continuity or discontinuity of electricity in a predetermined area of the identification information holding means where said identification information is held.

33. The inspection device according to claim 25, wherein said recognition device is structured so as to be capable of detecting a predetermined stereoscopic structure and recognizing said identification information indicated by said stereoscopic structure.

34. The inspection device according to claim 26,
wherein said sensor is constructed so as to be capable of detecting whether a key corresponding to a predetermined identification information engages with a key seat structure created corresponding to said identification information; and
said recognition device judges that the dispenser corresponding to said key seat structure has the identification information corresponding to said key when said sensor recognizes that said key has engaged.

35. An inspection method comprising the steps of:
recognizing identification information which is provided corresponding to a dispenser for discharging liquid;
transporting said dispenser corresponding to said identification information to a predetermined discharge position based on said recognized identification information; and
allowing said dispenser transported to said discharge position to discharge said liquid.

36. A biochip manufactured by the inspection method according to claim 35,
wherein said liquid identified by said identification information is polymer material; and
said biochip comprises a plate on which said polymer material is attached at a position corresponding to said identified identification information.
